(19) United States
(12) Patent Application Publication
(10) Pub. No.: US 2011/0001077 A1
(43) Pub. Date: Jan. 6, 2011

(54) MODULATOR VALVE ASSEMBLY HAVING AN ANTI-BACKLASH DEVICE

(75) Inventor: Mark Geoffrey Masen, Royal Oak, MI (US)

Correspondence Address: HOWARD & HOWARD ATTORNEYS PLLC, 450 West Fourth Street, Royal Oak, MI, 48067, US

(73) Assignee: MAXITROL COMPANY, Southfield, MI (US)

(21) Appl. No.: 12/829,141

(22) Filed: Jul. 1, 2010

Related U.S. Application Data
(60) Provisional application No. 61/222,334, filed on Jul. 1, 2009.

(51) Int. Cl. F16K 1/00

(52) U.S. Cl. 251/321; 251/318

(57) ABSTRACT

A modulator valve assembly including a housing defining fluid inlet and outlet passages, and a valve member which moves along an axis within the housing, the valve member having first and second positions separated along the axis, and operably disposed between the fluid inlet and outlet passages. The variable size of an opening through which the fluid inlet and outlet passages are in fluid communication within the housing is at least partially defined by the valve member, the opening respectively having first and second sizes when the valve member is in its first and second positions. The axis of rotation of the output of a reversible motor is substantially aligned with the axis along which the valve member moves. The motor output and valve member are operably engaged through relatively rotatable threaded male and female portions of a joint, the threads of the joint male and female portions interengaged. One of the male and female portions is rotatably fixed to the motor output, and the valve member is axially fixed to the other, whereby the valve member is moved axially in response to rotation of the motor output. The threads of the male and female portions each have a first surface that generally faces a first direction and a second surface that generally faces a second, substantially opposite direction. The first thread surface of one of the male and female portions is biased into continuous contact with the second thread surface of the other.

### CROSS-REFERENCE TO RELATED APPLICATION(S)

The instant application claims priority to U.S. Provisional Patent Application Ser. No. 61/222,334, filed Jul. 1, 2009, entitled MODULATOR VALVE ASSEMBLY HAVING AN ANTI-BACKLASH DEVICE, the entire specification of which is expressly incorporated herein by reference.

### BACKGROUND OF THE INVENTION

1. Field of the Invention

The present invention relates to a modulator valve assembly for regulating fluid flow along a fluid flow path, and more particularly to controlling valve positioning and fluid flow in a modulator valve assembly.

2. Description of the Related Art

Fluid flow modulator valve assemblies are known in which a controllably rotated motor, such as a step motor, moves a valve member linearly to variably open a port or opening through which a fluid flows. The position and movement of the valve is controlled through motor actuation to selectively permit and modulate the permitted flow of fluid through the opening and thus through the valve assembly. It is also known to operably engage a reversible rotating motor output and such a linearly moveable valve member through a threaded joint or coupling having interconnected male and female portions, one of which is fixed to rotate with the motor output, the other of which is axially fixed to the linearly moveable valve member. Thus, rotation of the motor is translated by the threaded coupling or joint into linear valve movement, the valve member moved linearly back and forth along an axis between different positions relative to the opening in response to reversible rotation of the motor output.

A problem with such prior valve assemblies is that a certain degree of backlash is experienced when reversing the motor from its most recent direction of rotation, which results in a time delay in the valve movement relative to motor output movement and system hysteresis, which compromises valve control. This occurs because the male and female threaded joint portions have one pair of interfacing thread surfaces slidably engaged during valve movement in one direction, and a different, opposite pair of interfacing thread surfaces slidably engaged during valve movement in the opposite direction, the lash or clearance between the interengaged threads of the joint first requiring traversal before reversed rotation of the motor output effects reversed linear movement of the valve. This traversal may be referred to as “backlash.”

Prior modulator valve assemblies including such threaded couplings or joints between the motor output and the valve member have addressed this concern through selectively matching the threaded male and female portions of the joint to minimize the clearance between their interengaged threads. In other words, the threadably interengaged joint connection portions are selected such that the interfacing surfaces on opposed sides of their interengaged threads are, to some extent, brought into closer proximity with each other and minimizing lash, preferably without compromising the ability of the threadably interengaged male and female portions to easily rotate relative to each other and thus move axially relative to each other. Alternatively, very close thread manufacturing tolerances are maintained to similarly minimize lash without selective matching. Either approach is an expensive and/or time-consuming process, and does not fully address the problems of delay and hysteresis, for with it some backlash will still be present.

Further, the sourcing of the motor, valve member and/or intervening threaded coupling or joint portions may complicate their being assembled in a manner that ensures backlash is minimized. For example, these components may be manufactured by different entities, complicating the coordination and undermining the convenience of selective thread matching or adhering to close thread tolerance requirements.

Achieving greater valve control without resorting to selective thread matching or requiring closer thread manufacturing tolerances is therefore desirable.

Additionally, the poppet valves of prior modulator valve assemblies typically give an output response that resembles a second order polynomial or a logarithmic function of the input. Controlling fluid flow using a modulator valve assembly having such an output response can be problematic with newer controllers, which work best with a linear output. For example, if one were to differentiate a second order polynomial, the result would be an equation representing a straight line. This straight line, however, has a slope other than zero, meaning that the valve assembly output response is more and less responsive per unit input at different positions throughout the valve member's travel, a phenomenon known as the modulator valve assembly having a varying “gain.”

If, however, the modulator valve assembly is designed to have a linear output response per unit input (represented by a straight, sloping line), then its derivative at any point in its valve member's travel will be a constant, meaning that the valve assembly output response for a given unit input is constant throughout the entire range of valve member travel, i.e., the modulator valve assembly gain is constant. Modulator valve assembly controllers are programmed to respond to a given error. However, the same error can occur at any point of the valve travel. Therefore, these controllers work best with a constant gain, which facilitates a consistent, more easily controlled output response.

Notably, however, even if constant gain is achieved, valve assembly output response can be affected by variables such as, for example, supply line pressure. Thus, tailoring the valve assembly output response to achieve desired performance in particular circumstances may also be necessary.

It is therefore also desirable to provide a modulator valve assembly with the ability to have constant gain, but which facilitates easily tailoring the valve assembly output response to deviate from a linear function of its input as circumstances warrant.

Thus, it would be advantageous to provide a modulator valve assembly that overcomes at least one of the aforementioned problems.

### BRIEF SUMMARY OF THE INVENTION

An object of the present invention is to eliminate backlash between the rotatable motor output and the linearly movable valve member, which are operably engaged through a threaded joint having interengaged male and female portions, in a modulator valve assembly. An anti-backlash device provides a biasing force that is applied in such a way as to keep one side of the thread of the joint portion axially fixed to the valve member against one side of the thread of the joint portion rotatably fixed to the motor output at all times, regardless of motor rotating direction, whereby a change in rotational direction of the step motor is realized immediately at the valve member, thereby eliminating output hysteresis.

Another object of the present invention is to facilitate easily tailoring a modulator valve assembly output response to account for affecting circumstances particular to its installation, use and application, to achieve desired performance. The output response may be altered through selection of a characteristic insert that may be one of a plurality of interchangeable tubular members removably disposed within the modulator valve assembly housing, its cylindrical axis collinear with the axis of valve travel, the valve moving within the tubular member to create and vary the area size of an opening or port in the wall of the tubular member through which a fluid flows, yielding a valve assembly output response to valve input step. The selected characteristic insert may provide an opening or port shape or profile that produces a linear or a non-linear output response, and that may be tailored to accommodate performance-affecting factors such as, for example, supply line pressure, in achieving desired performance. Quick and easy removal and replacement of the characteristic insert with one providing a different opening or port shape and/or size is facilitated by the present invention.

In addition to, or as an alternative to, providing the modulator valve with a plurality of different characteristic inserts, the valve's output response may be altered through the selective adjustment by a user, of minimum and maximum endpoints of the valve member as it moves toward an open position along a tubular insert member, the stroke endpoints defining the limit of a range of travel over which the control signal is scaled. The adjustment of the minimum and maximum open position endpoints in the stroke can be appropriately matched to a constant supply line pressure, or used with a corresponding adjustment to the supply line pressure, to yield a desired output characteristic. For example, supply line pressure may be increased and the valve's maximum opening stroke endpoint reduced to achieve the same maximum output as can be realized through having lower supply line pressure and greater maximum valve stroke, but with more linear output characteristic. Essentially, the valve may be operated on a narrower portion of the “logarithmic” output characteristic and experience less slope change over the operating range. The opening stroke endpoint position being adjustable between minimum and maximum can be easily facilitated through motor control features.

The present invention provides a modulator valve assembly including a housing defining a fluid inlet passage through which fluid enters the housing, a fluid outlet passage through which fluid exits the housing, and a valve member which moves along an axis within the housing, the valve member having first and second positions separated along the axis and is operably disposed between the fluid inlet and outlet passages. The variable size of an opening through which the fluid inlet and outlet passages are in fluid communication within the housing is at least partially defined by the valve member, the opening having a first size when the valve member is in its first position and a second size when the valve member is in its second position. The modulator valve assembly further includes a motor having a reversibly rotating output, the motor output having an axis of rotation substantially aligned with the axis along which the valve member moves, and a joint having threaded male and female portions through which the motor output and the valve member are operably engaged. The threads of the joint male and female portions are interengaged and the joint male and female portions are relatively rotatable. One of the male and female portions is rotatably fixed to the motor output, and the valve member is axially fixed to the other of the joint male and female portions, whereby the valve member is moved axially in response to rotation of the motor output. The threads of the male and female portions each have a first surface that generally faces a first direction and a second surface that generally faces a second, substantially opposite direction, and the first thread surface of one of the male and female portions is biased into continuous contact with the second thread surface of the other of the male and female portions.

The present invention also provides a modulator valve assembly including a housing having a fluid inlet passage and a fluid outlet passage, an interchangeable characteristic insert removably disposed in the housing, the characteristic insert having a wall in which there is a void defined by an edge, the fluid inlet and outlet passages located on opposite sides of the wall. The modulator valve assembly further includes a valve member disposed in the housing and moveable between variable positions along an axis, the valve member positions sequentially arranged with a common fixed distance between adjacent valve member positions along the axis. The modulator valve assembly further includes a reversible motor having an output, and a joint at all times devoid of backlash disposed between the valve member and the motor output through which the motor output and the valve member are operably engaged. The valve member is in sliding engagement with the wall, and the void edge and the valve member define a port in the wall through which the fluid inlet and outlet passages are placed in fluid communication with each other, the port having a variable flow area size partially defined by the variable position of the valve member. The characteristic insert is a selected one of a plurality of interchangeable characteristic inserts each having a void that is different from the void of another characteristic insert of the plurality.

Further aspects of the present invention will become apparent from the detailed description provided hereinafter. It should be understood that the detailed description of a specific example, while indicating a preferred embodiment of the invention, is intended for purposes of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an exterior perspective view of a modulator valve assembly in accordance with one embodiment of the present invention;

FIG. 2 is a side view of the modulator valve assembly of FIG. 1;

FIG. 3 is an end view of the modulator valve assembly of FIG. 1, looking into its fluid inlet passage;

FIG. 4 is an end view of the modulator valve assembly of FIG. 1, looking into its fluid outlet passage;

FIG. 5 is a fragmented, partially sectioned perspective view of the modulator valve assembly along line 5-5 of FIG. 3, in a fully closed state and showing its valve member in ghosted lines;

FIG. 6 is a fragmented, partially sectioned perspective view of the modulator valve assembly along line 6-6 of FIG. 3, in a fully open state and showing its valve member in ghosted lines;

FIG. 7 is a fragmented, sectioned view of the modulator valve assembly along line 7-7 of FIG. 3, in a fully closed state and showing its valve member in ghosted lines;

FIG. 8 is an enlarged, fragmented view of area 8 of FIG. 7, showing the interengaged threads of the joint or coupling through which the motor output and valve member are operably engaged;

FIG. 9 is an enlarged, fragmented view of FIG. 7 showing the valve member in a first position in which the modulator valve assembly is in an open state;

FIG. 10 is an enlarged, fragmented view of FIG. 7 showing the valve member in a second position in which the modulator valve assembly is in an open state;

FIG. 11 is an enlarged, fragmented view of FIG. 7 showing the valve member in a third position in which the modulator valve assembly is in a fully open state;

FIG. 12 is a perspective view of an exemplary characteristic insert shown removed from the modulator valve assembly of FIGS. 1-11; and

FIG. 13 is a sectioned, perspective view of the characteristic insert of FIG. 12 along line 13-13.

Corresponding reference characters indicate corresponding parts throughout the several views. While the invention is susceptible to various modifications and alternative forms, a specific embodiment of it by way of example is shown in the drawings and described in detail herein. It should be understood, however, that the drawings and detailed description that follows are not intended to limit the invention to the particular form disclosed, but on the contrary, the intention is to cover all modifications, equivalents and alternatives falling within the spirit and scope of the present invention as defined by the appended claims.

Moreover, it is to be noted that the Figures are not necessarily drawn to scale or to the same scale. In particular, the scale of some of the elements of the Figures may be greatly exaggerated to emphasize characteristics of the elements. Elements shown in more than one Figure that may be similarly configured have been indicated using the same reference numerals.

### DETAILED DESCRIPTION OF THE EXEMPLARY EMBODIMENT(S)

The following description of a preferred embodiment is merely exemplary in nature and is in no way intended to limit the invention or its uses.

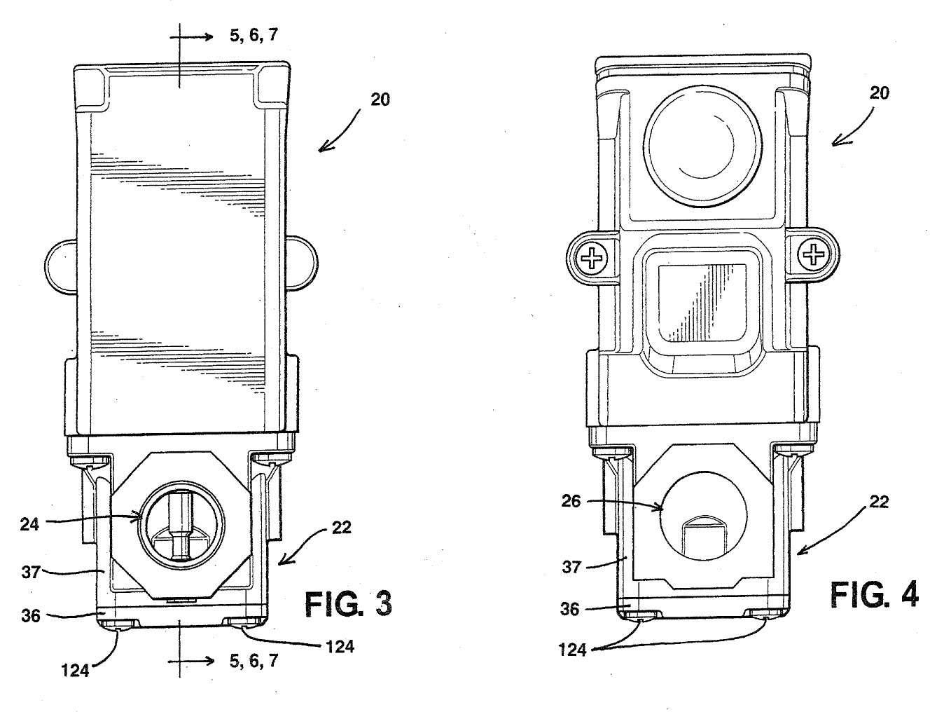

FIGS. 1 through 4 show exterior views of modulator valve assembly 20 which includes housing 22 including fluid inlet passage 24 and fluid outlet passage 26, which are in selective and variable fluid communication with each other within housing 22. The direction of fluid flow into passage 24 and out of passage 26, and through modulator valve assembly 20, is indicated by arrows 25 and 27, the upstream pressure of fluid at inlet passage 24 normally being higher than the downstream pressure at outlet passage 26. Inlet and outlet passages 24, 26 may be internally threaded (not shown), by which fitted connections to upstream and downstream fluid conduits (not shown) can be made in an ordinary, well-known manner.

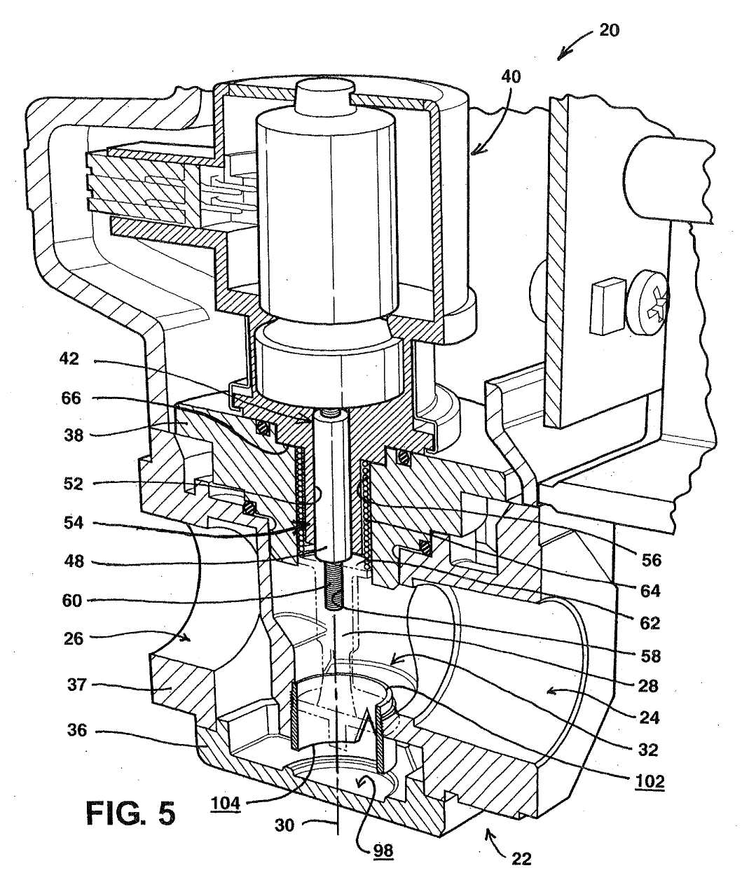

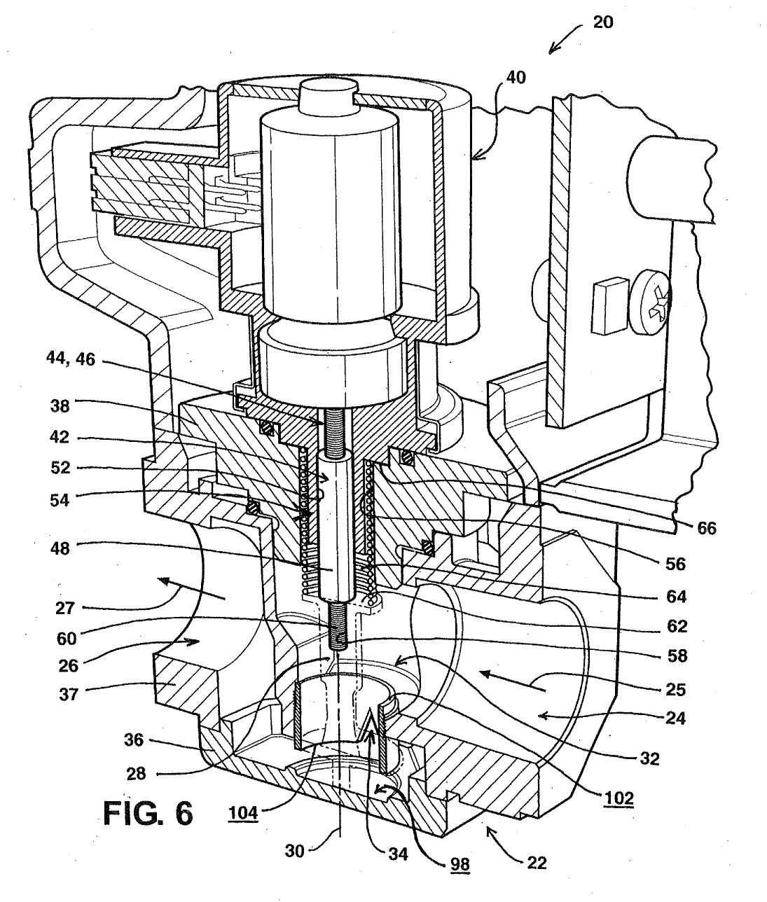

Referring to FIGS. 5-7, which variously show modulator valve assembly 20 in fully closed and fully open states or conditions, the valve assembly further includes somewhat cylindrical valve member 28 (shown in ghosted lines in all Figures) which is linearly moveable along axis 30 within passageway 32, which is located between fluid inlet passage 24 and fluid outlet passage 26. The central axis of elongate valve member 28 coincides with axis 30. When modulator valve assembly 20 is moved into an open state, opening or port 34 of variable size (FIG. 6) is created, through which a fluid may flow into passageway 32 and between passages 24 and 26. When modulator valve assembly 20 is in a fully closed state, in which inlet and outlet passages 24, 26 are out of fluid communication with each other through passageway 32, opening or port 34 is nonextant. In other words, in the fully closed state, in which inlet and outlet passages 24, 26 are out of fluid communication with each other through passageway 32, the size of opening or port 34 is substantially zero, i.e., there exists no opening 34 through which fluid can flow between passages 24 and 26.

Modulator valve assembly housing 22 further includes cover 36 sealably and removably attached to body 37 of housing 22 below valve member 28. Motor mount 38 is sealably affixed to housing body 37 above valve member 28. Attached to motor mount 38 is step motor 40 having a rotor provided with reversible rotatable output 44 (FIG. 6). Motor output 44 has the configuration of or encompasses reversibly rotatable threaded shaft 46, which is the male portion of threaded joint or coupling 42 to be described further below and which is disposed between motor 40 and valve member 28. Thus, male portion 46 of coupling 42 is rotatably fixed to motor output 44.

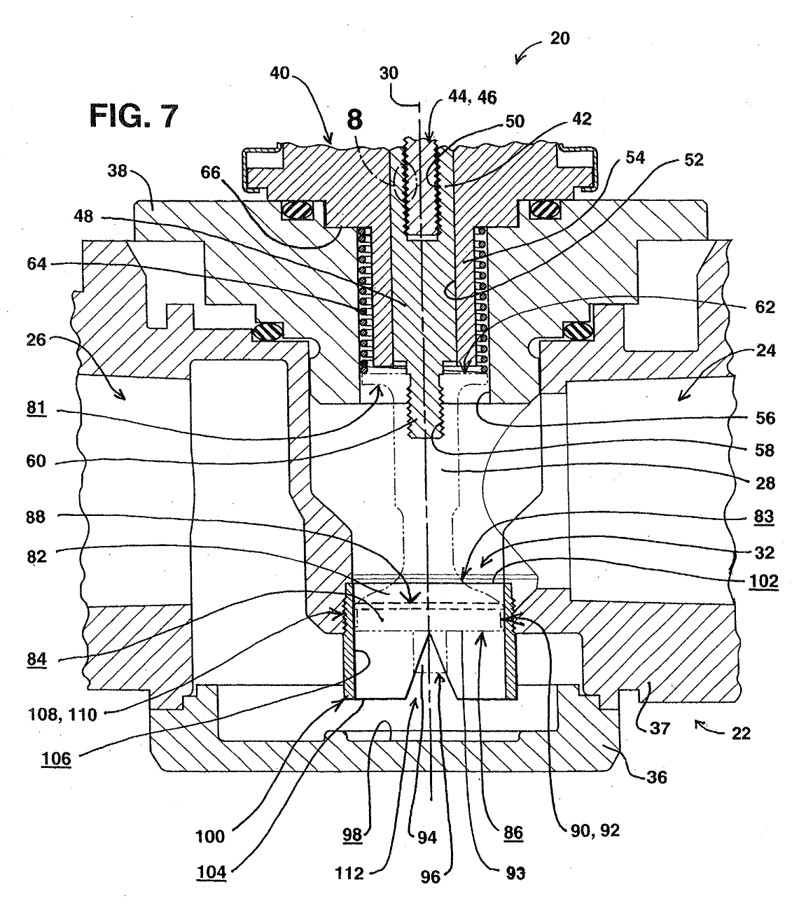

Valve assembly 20 further includes generally cylindrical valve stem 48 which is provided with threaded bore 50 (FIG. 7) in which treaded motor shaft 46 is received, and is the female portion of threaded joint or coupling 42. Valve stem 48 is fixed against rotation with motor shaft 46 and relative to housing extension 54 of motor 40, and responsive to rotation of motor shaft 46 valve stem 48 undergoes linear movement along axis 30. Valve stem 48 is slidably disposed in bore 52 of motor housing extension 54. Motor 40 may be obtained as a subassembly product that includes valve stem 48 disposed in housing extension 54 and threaded onto output shaft 46 from a motor supplier such as, for example, Saia-Burgess USA Inc., 801 Scholz Drive, Vandalia, Ohio 45377 (www.saia-burgessusa.com), for use in modulator valve assembly 20. Motor mount 38, to which motor 40 may be fixed during final assembly of modulator valve assembly 20, is provided with bore 56 into which motor housing extension 54 is inserted, with bore 56, motor housing extension 54 and valve stem 48 coaxially disposed relative to axis 30.

The upper axial end of valve member 28 is provided with centrally located threaded bore 58 in which is received axially extending threaded shaft portion 60 of valve stem 48. Valve member 28 and valve stem 48 are fixed together against relative movement therebetween through the threaded engagement of bore 58 and shaft portion 60. A thread adhesive such as LOCTITE™ may be applied to the threads of bore 58 and shaft portion 60 to ensure the fixed relationship of valve stem 48 and valve member 28.

The upper axial end of valve member 28 is formed with centered annular spring seat 62 disposed about threaded bore 58, planar spring seat 62 extending radially outward and normal to axis 30. The outer diameter of spring seat 62 is sized to be received within bore 56 of motor mount 38, as best shown in FIG. 7.

Compression spring 64 is a generally cylindrical coiled spring disposed about motor housing extension 54 and axis 30, with one end in abutting contact with spring seat 62 and the opposite end in abutting contact with annular motor housing shoulder 66 formed about motor housing extension 54. As best understood with reference to FIGS. 5-7, compressed spring 64 continually exerts downward force along axis 30 on valve member 28 which urges it away from motor 40.

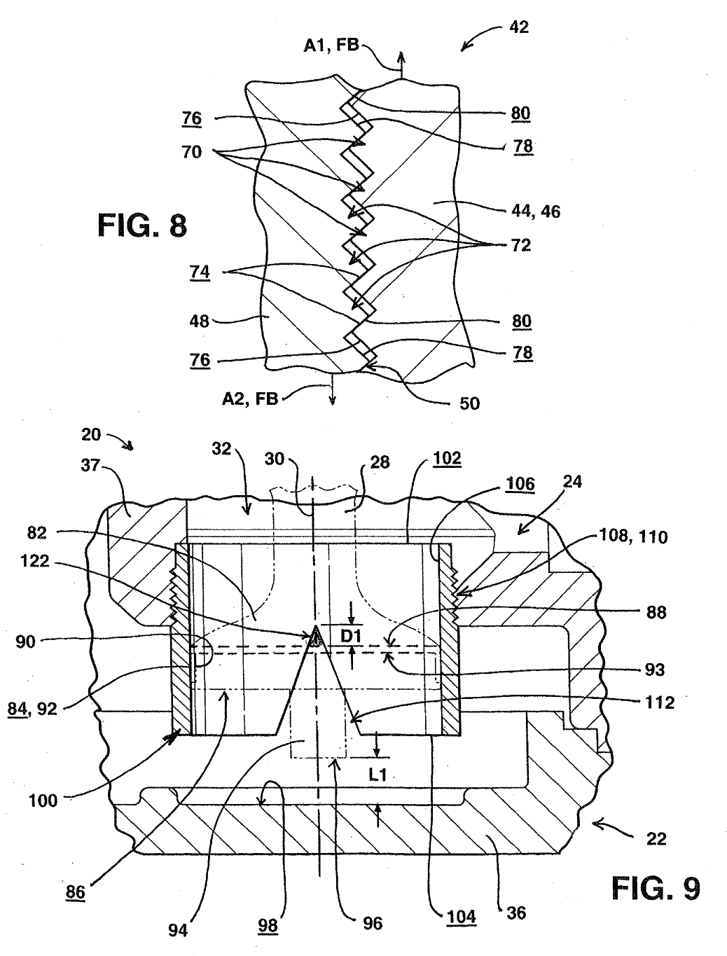

Referring now to FIG. 8, threaded joint or coupling 42, through which motor output 44 and valve member 28 are operably engaged, includes thread 70 of shaft 46, which forms the male portion of joint 42 and which is rotatably fixed to or forms a portion of motor output 44, and thread 72 of bore 50 of valve stem 48, which forms the female portion of joint 42 and which is axially fixed to valve member 28, threads 70 and 72 being interengaged. In response to relative rotation between shaft 46 and valve stem 48, their threads 70 and 72, and thus shaft 46 and valve stem 48 themselves, move axially relative to each other along axis 30, effecting linear movement of valve member 28 within housing 22. As mentioned above, valve stem 48 is fixed against rotation within motor housing extension 54, for example by keyed, axial sliding engagement therebetween, and thus the reversible rotation of motor output 44 produces reversibly linear movement, without rotation, of valve member 28 along axis 30 in housing 22.

Referring still to FIG. 8, thread 70 of motor output shaft 46 has first helical surface 74 that generally faces a first, upward direction indicated by arrow A1, and second, opposite helical surface 76 that generally faces a second, downward direction indicated by arrow A2. Thread 72 of valve stem bore 50 has first helical surface 78 that generally faces the first, upward direction indicated by arrow A1, and second, opposite helical surface 80 that generally faces the second, downward direction indicated by arrow A2. In modulator valve assembly 20, these helical surfaces are oblique relative to axis 30, but are to be understood as being generally facing either upward or downward directions therealong.

Compression spring 64 exerts equal biasing forces FB in the opposite first and second directions respectively indicated by arrows A1 and A2. These forces bias first surface 74 of thread 70 into continuous abutting contact with second surface 80 of thread 72. In all states of valve operation and regardless of the direction of rotation of motor output 44, surfaces 74 and 80 remain in abutting (or when moving relative to each other, slidably abutting) contact, and there is at no time any separation of threads 70 and 72, which remain in contact through their abutting surfaces 74 and 80. Therefore, the backlash encountered in prior modulator valve assemblies, which typically occurs upon their motor outputs reversing their prior directions of rotation, is eliminated in modulator valve assembly 20. Thus, joint or coupling 42 is provided with an anti-backlash device that includes spring 64, spring seat 62 and shoulder 66 between which spring 64 acts, and interengaged surfaces of threads 70, 72 of the male and female portions of joint or coupling 42. Those of ordinary skill in the art will recognize that the anti-backlash device could alternatively be configured to provide a biasing force that maintains first surface 78 of thread 72 into continuous abutting (or slidably abutting) contact with second surface 76 of thread 70, to produce a similar anti-backlash effect. Thus, the need to selectively match or maintain close manufacturing tolerances of the threads of coupling or joint 42 to minimize delay and hysteresis, as done in prior art modulator valve assemblies, is obviated in modulator valve assembly 20.

Referring to FIGS. 7 and 8, those of ordinary skill in the art will also appreciate that, to some extent, the direction of fluid flow through modulator valve assembly 20, the relative upstream and downstream fluid pressures, and the relative sizes of smaller, annular underside surface 81 of valve member spring seat 62 and the larger, generally upwardly facing annular surface 83 of valve member head 82, further tends to urge valve member 28 downwardly along axis 30 and thus bias second surface 80 of thread 72 into contact with first surface 74 of thread 70 in joint 42. This arrangement facilitates the fluid itself exerting on valve member 28 an additional, downwardly directed biasing force along axis 30 which urges it away from motor 40, thereby supplementing the biasing force provided by spring 64 to further support the elimination of backlash in joint 42.

Referring again to FIGS. 5-7, circular valve head 82 formed on valve member 28 has cylindrical circumferential surface 84 defined on its lowermost end by planar axial end surface 86. The opposite, uppermost end of cylindrical surface 84, at its juncture with annular surface 83, is defined by circular edge 88 (shown as a dashed line in FIGS. 7 and 9-11). Cylindrical surface 84 is optionally provided with circumferential groove 90 in which is disposed band seal 92. The upper end of band seal 92, if present, defines in valve head 82 another circular edge 93 (also shown as a dashed line in FIGS. 7 and 9-11).

Projecting from axial end surface 86 of valve head 82, along axis 30, is projection 94 having terminal end or tip 96. Tip 96 is brought into abutting engagement with interior surface 98 of cover 36 when valve member 28 is in its maximum, fully opened position. That is to say, the travel of valve member 28 is limited in its direction away from motor 40 by the abutting engagement of tip 96 and cover surface 98.

Disposed within housing 22 and partially defining passageway 32 is tubular member 100 having opposed axial end surfaces 102 and 104 between which is defined interior cylindrical sidewall surface 106 which is in slidably sealing engagement with cylindrical surface 84 and/or seal 92 of valve head 82. Optional groove 90 and band seal 92 provides enhanced sealing engagement between valve head 82 and cylindrical sidewall surface 106 when modulator valve assembly 20 is in its fully closed position (FIGS. 6 and 7), further ensuring the prevention of any fluid flow between passages 24 and 26. Tubular member 100, surface 106 of which defines part of passageway 32, is secured within housing 22 through the sealing engagement of its threads 108 with threads 110 provided in housing body 37.

Tubular member 100 is provided with void or notch 112 that is cut into the wall thereof, one end of void 112 being open to lower axial end surface 104 of tubular member 100. Void or notch 112 thus extends from axial end surface 104 towards annular, axial end surface 102 of tubular member 100.

The shape of void or notch 112 is selected, defined or calculated to achieve the desired modulator valve assembly output response in view of the factors affecting flow and its modulation, and may be, for example, generally rectangular, generally triangular (as shown), or any other shape determined to provide the desired output response to a unit of input defined as being, or being directly proportional to, each stepped linear movement of valve member 28 along axis 30 responsive to the corresponding stepped angular movement of motor output 44 from one position to the next, which the above-described anti-backlash device ensures to be immediate and without hysteresis.

The illustrated triangular shape of void 112 in tubular member 100 is exemplary only. A rectangular void would produce a more linear modulator valve assembly output response to the incremental linear movement of valve member 28 (and thus a substantially constant gain) but, as mentioned above, in tubular member 100 the defining edge of void 112 (and thus of port 34) may be tailored to any shape determined to yield the desired output response in view of circumstances particular to the installation, use and application of the modulator valve assembly, to achieve the desired performance. The shown substantially triangular shape of the edge defining void 112, which has vertex 114 formed by the intersection of opposite sides 116 and 118 separated by angle θ and the base defined by open segment 120 in otherwise annular axial surface 104, provides a modulator valve assembly output response that may be a second order polynomial.

For the purposes of illustration, with reference to FIG. 9, one of ordinary skill in the art will appreciate that the uppermost portion 122 of the edge defining void 112, near vertex 114, when valve head circular edge 88 (or optionally, the upper edge 93 of band seal 92) is located below void edge portion 122 at distance D1, presents a port 34 of an initial size (shown shaded in FIG. 9) that directly corresponds to a first stepped position of valve member 28 along axis 30, and through which passages 24 and 26 are in fluid communication through passageway 32. In this valve position, tip 96 of valve member projection 94 is distanced above cover interior surface 98 by distance L1.

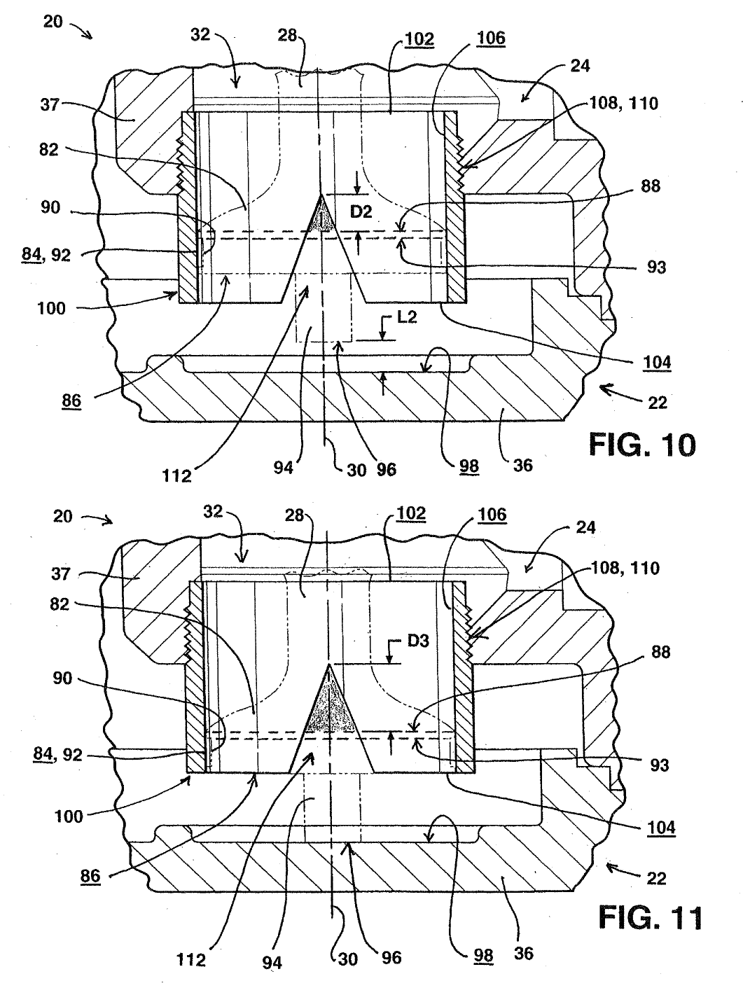

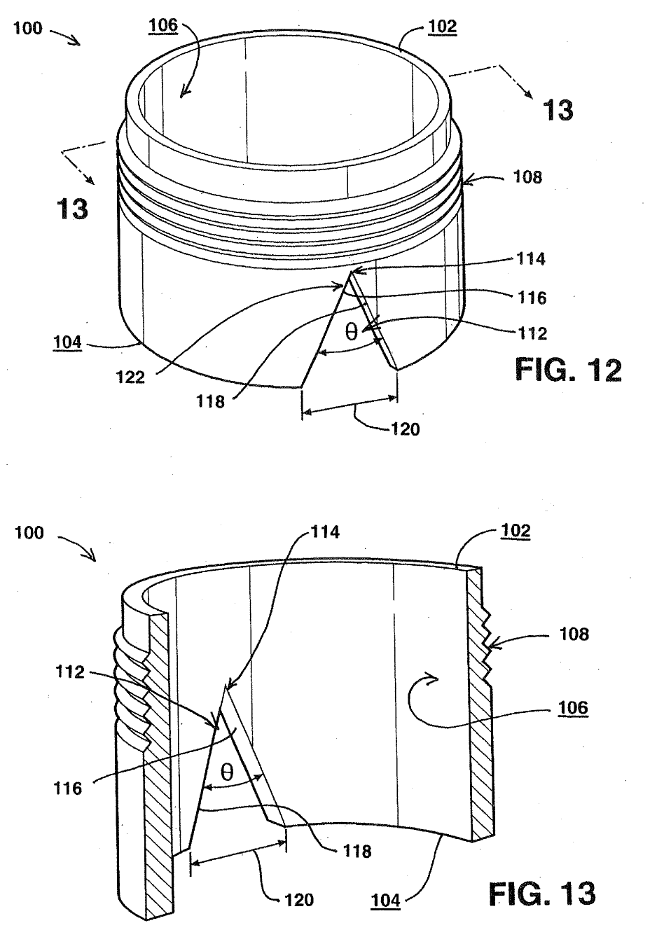

In reaching the adjacent incremental stepped position of valve member 28 along axis 30, shown in FIG. 10, in which distance D1 has increased by a fixed, incremental amount to distance D2 (and distance L1 has decreased to distance L2) port 34 (shown shaded) has been correspondingly enlarged.

In reaching the further adjacent incremental stepped position of valve member 28 along axis 30, shown in FIG. 11, in which distance D2 has further increased by a fixed, incremental amount to distance D3 (and distance L2 has decreased to zero, with tip 96 abutting cover interior surface 98) port 34 (shown shaded) has been correspondingly enlarged to the maximum area afforded by the characteristic insert that is tubular member 100.

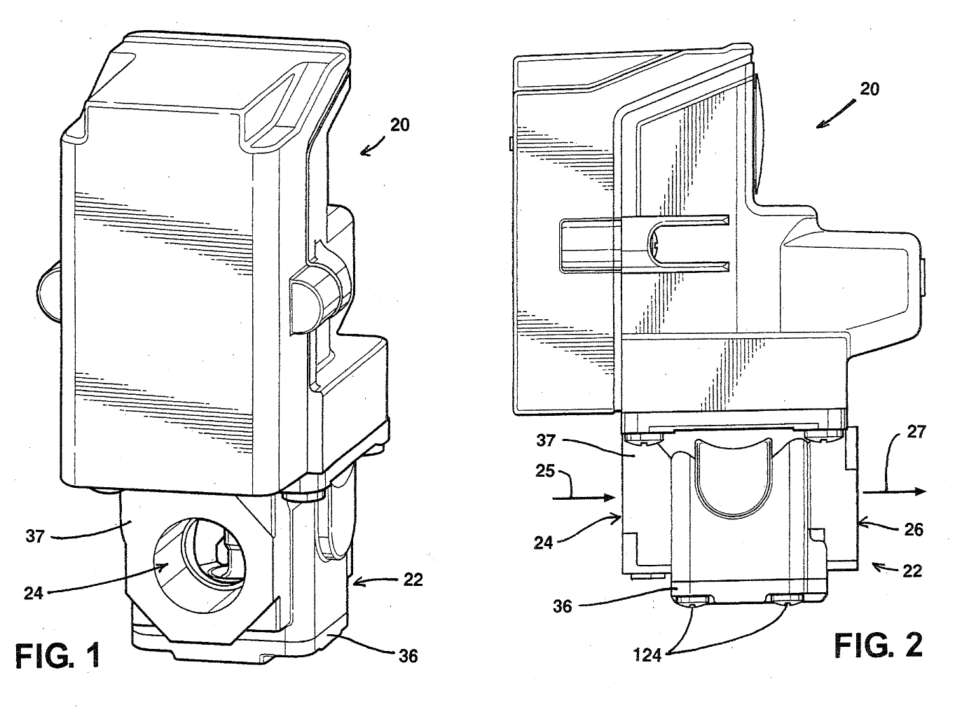

Tubular member 100 may be one of a plurality of interchangeable characteristic inserts distinguished by the size and shape of its void 112, each facilitating in modulator valve assembly 20 a different output response (e.g., the change in flow area of port 34) per unit of input (e.g., the fixed incremental amount of travel along axis 30 between D1 and D2, or between D2 and D3). The valve assembly output response may be tailored to accommodate circumstances particular to the installation, use and application, to achieve desired performance, by substituting the shown tubular member 100 for another having a different void-defining edge in its sidewall. Substitution of one characteristic insert for another entails removing cover 36 from housing body 37 (held in place with a plurality of screws 124 as shown in FIGS. 2-4), unscrewing the threaded tubular member 100 from housing body 37 and removing it from housing 22, installing a selected replacement tubular member having a different void size or shape, and reinstalling cover 36.

In addition to, or as an alternative to, providing the modulator valve 20 with a plurality of different characteristic inserts 100, the valve's output response may be altered through the selective adjustment by a user, of minimum and maximum endpoints of the valve member 28 as it moves toward an open position along a tubular insert member 100, the stroke endpoints defining the limit of a range of travel over which the control signal is scaled. The adjustment of the minimum and maximum open position endpoints in the stroke can be appropriately matched to a constant supply line pressure, or used with a corresponding adjustment to the supply line pressure, to yield a desired output characteristic. For example, supply line pressure may be increased and the valve's maximum opening stroke endpoint reduced to achieve the same maximum output as can be realized through having lower supply line pressure and greater maximum valve stroke, but with more linear output characteristic. Essentially, the valve may be operated on a narrower portion of the “logarithmic” output characteristic and experience less slope change over the operating range. The opening stroke endpoint position being adjustable between minimum and maximum can be easily facilitated through motor control features.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or type of fluid medium to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A modulator valve assembly comprising:
a housing defining a fluid inlet passage through which fluid enters said housing, and a fluid outlet passage through which fluid exits said housing;
a valve member which moves along an axis within said housing, said valve member having a first position and a second position separated along said axis, said valve member operably disposed between said fluid inlet and outlet passages, the variable size of an opening through which said fluid inlet and outlet passages are in fluid communication within said housing at least partially defined by said valve member, said opening having a first size when said valve member is in its said first position and a different second size when said valve member is in its said second position;
a motor having a reversibly rotating output, said motor output having an axis of rotation substantially aligned with the axis along which said valve member moves; and
a joint having threaded male and female portions through which said motor output and said valve member are operably engaged, the threads of said joint male and female portions interengaged and said joint male and female portions relatively rotatable, one of said male and female portions rotatably fixed to said motor output, said valve member axially fixed to the other of said joint male and female portions, whereby said valve member is moved axially in response to rotation of said motor output;
said threads of said male and female portions each having a first surface that generally faces a first direction and a second surface that generally faces a second, substantially opposite direction, said first thread surface of one of said male and female portions biased into continuous contact with said second thread surface of the other of said male and female portions.

2. The modulator valve assembly of claim 1, wherein said modulator valve assembly has a fully closed state defined by the position of said valve member in which said opening is nonextant, and said first and second fluid passages are out of fluid communication within said housing.

3. The modulator valve assembly of claim 2, wherein the existence of said opening is through movement of said valve member from a position along its axis of movement that defines said fully closed state of said modulator valve assembly.

4. The modulator valve assembly of claim 1, wherein said valve member and the axially moveable one of said joint male and female portions are substantially nonrotative relative to said housing.

5. The modulator valve assembly of claim 1, further comprising a spring, a force between said joint male and female portions induced by said spring along the axis along which said valve member moves, wherein said first thread surface of one of said joint male and female portions is biased into continuous contact with said second thread surface of the other of said male and female portions by said spring-induced force.

6. The modulator valve assembly of claim 5, wherein said valve member is biased away from said motor along said axis by said spring-induced force.

7. The modulator valve assembly of claim 5, wherein said spring is a compression spring.

8. The modulator valve assembly of claim 7, wherein said compression spring comprises a coil disposed about the axis along which said valve member moves.

9. The modulator valve assembly of claim 1, further comprising a compressed coil spring disposed about the axis along which said valve member moves and between said motor and said valve member.

10. The modulator valve assembly of claim 9, wherein said valve member includes a spring seat, one end of said spring in contact with said spring seat.

11. The modulator valve assembly of claim 1, wherein said valve member includes a head and said housing is provided with a passageway in which said opening exists in an open state of said modulator valve assembly, said valve member head in sliding engagement with said passageway, said opening nonextant in a fully closed state of said modulator valve assembly.

12. The modulator valve assembly of claim 11, wherein the variable size of said opening is at least partially defined by said valve member head in an open state of said modulator valve assembly.

13. The modulator valve assembly of claim 11, wherein said valve member head has a circumferential surface in sliding engagement with said passageway and defining an edge, said edge at least partially defining the variable size of said opening.

14. The modulator valve assembly of claim 13, wherein said valve member head circumferential surface is substantially cylindrical and the portion of said passageway with which said head circumferential surface is in sliding engagement is substantially cylindrical.

15. The modulator valve assembly of claim 14, wherein said opening is in said cylindrical passageway portion.

16. The modulator valve assembly of claim 11, wherein said passageway has a sidewall in which said opening is located, fluid communication between said fluid inlet and outlet passages through said passageway at least partially blocked by said valve member head in said valve member first position, and said opening first size is smaller than said opening second size.

17. The modulator valve assembly of claim 16, wherein, in a fully closed state of said modulator valve assembly, fluid communication between said fluid inlet and outlet passages through said passageway is completely blocked, and said opening first size is substantially zero.

18. The modulator valve assembly of claim 16, further comprising a selected one of a plurality of interchangeable tubular members, said selected tubular member extending along the axis along which said valve member moves, the inner surface of said selected tubular member at least partially defining said passageway, the sidewalls of different ones of said plurality of interchangeable tubular members having differing voids that partially define said opening when each different one of said plurality of tubular members is alternatively said selected one of said plurality of tubular members, and by which said interchangeable tubular members are distinguished from one another.

19. The modulator valve assembly of claim 16, wherein said opening has a shape partially defined by an edge portion in said passageway that is proximate said valve member head in said valve member first position, the size of said opening increased with movement from said valve member first position toward said valve member second position.

20. The modulator valve assembly of claim 19, wherein said valve member head has a circumferential surface in sliding engagement with said passageway and defining an edge, said opening partially defined by said valve head edge.

21. The modulator valve assembly of claim 20, further comprising a tubular member extending along the axis along which said valve member moves, the inner surface of said tubular member defining at least a portion of said passageway, said tubular member having a void extending from one end of said tubular member toward the opposite end of said tubular member.

22. The modulator valve assembly of claim 21, wherein said void is a notch cut into the wall of said tubular member at one end thereof.

23. A modulator valve assembly, comprising:
a housing having a fluid inlet passage and a fluid outlet passage;
an interchangeable characteristic insert removably disposed in said housing, said characteristic insert having a wall in which there is a void defined by an edge, said fluid inlet and outlet passages located on opposite sides of said wall; and
a valve member disposed in said housing, said valve member moveable between variable positions along an axis, said valve member positions sequentially arranged with a common fixed distance between adjacent said valve member positions along said axis;
a reversible motor having an output; and
a joint at all times devoid of backlash disposed between said valve member and said motor output through which said motor output and said valve member are operably engaged;
wherein said valve member is in sliding engagement with said wall, said void edge and said valve member define a port in said wall through which said fluid inlet and outlet passages are placed in fluid communication with each other, said port having a variable flow area size partially defined by the variable position of said valve member, and said characteristic insert is a selected one of a plurality of interchangeable characteristic inserts each having a void that is different from the void of another characteristic insert of said plurality.
